(19) United States
(12) Patent Application Publication
(10) Pub. No.: US 2003/0048908 A1
(43) Pub. Date: Mar. 13, 2003

(54) System and method for protecting the content of digital cinema products

(76) Inventor: Jon W. Hamilton, Austin, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 10/232,427

(22) Filed: Aug. 30, 2002

Related U.S. Application Data
(60) Provisional application No. 60/316,020, filed on Aug. 31, 2001.

(51) Int. Cl. H04L 9/00

(52) U.S. Cl. 380/277

(57) ABSTRACT

A system and method for copy protecting digital cinema products. Digital cinema products are protected by encryption using the encryption mode of a non-algebraic cryptographic engine (NACE) that permits digital content to be encrypted at exceptionally high data rates. Using a key ex change protocol, the user of an encrypted digital cinema product decrypts the encrypted digital cinema product using the decryption mode the NACE at data rates that allow the content to be viewed and/or displayed without the need for intermediate storage of the clear text data. To further protect the content of the digital cinema product, a black metamer imprinting engine (BMIE) is used to imprint the user's copy of the digital cinema product content with an identifier chosen by the originator.

### CROSS REFERENCE TO RELATED APPLICATIONS

This application claims priority under 35 U.S.C. § 119(e) from provisional application No. 60/316,020, filed Aug. 31, 2001. The 60/316,020 provisional application is incorporated by reference herein, in its entirety, for all purposes.

### FIELD OF INVENTION

This invention relates generally to copy protecting digital data. More particularly, the present invention relates to a system and method for copy protecting digital cinema products wherein the protected content can be viewed and/or displayed in real time without the need for intermediate storage of the clear text digital cinema product.

### BACKGROUND OF THE INVENTION

The movie industry is beginning to use digital cinemas and digital theater projection systems for showing of first-run cinemas. HDTV systems already provide consumers with the capability of showing digital cinematic products.

The first generation of digital cinemas requires wideband digital imagery. This has two components, first the total number of digital imagery bits and second, the rate in bits per second that the digital imagery product must be displayed. The first generation of digital cinemas requires a data rate of 1.8×10⁹ bits per second. This arises from a digital cinema product that displays 30 frames per second, frames of 2×10⁶ pixels, and pixels consisting of 30 bits each. If the digital cinema product is 1.5 hours long, then the total number of bits is 9.720×10¹² bits. Subsequent generations of digital cinema products will grow to 70 frames per second, having frames of 10⁷ pixels, and pixels of 36 bits each, requiring a data rate of 2.52×10¹⁰ bits per second, with data storage for the image of 1.37×10¹⁴ bits.

Providing content protection and storage for these data rates and quantities of data are daunting tasks. Data compression can help in both matters, by reducing the amount of data per frame, thus decreasing both storage requirements and data rates. However, it is an open question amongst cinematic producers as to the degree of compression that is acceptable without impact the artistic integrity of their product. In addition only compression techniques that adversely affect image quality provide any significant degree of data compression, and upon decompression do not produce the same quality image as before compression. In either case, with compression ratios limited to less than 10:1 and most probably less than 5:1 data, compression will not have a major effect on the data rate. Thus digital cinema projection systems using data compression would currently experience data rates of from 0.18×10⁹ bits per second up to 0.36×10⁹ bits per second. Succeeding generations of digital cinema would require data rates between 0.252×10¹⁰ bits per second to 504×10¹⁰ bits per second.

Digital cinema products have a high financial value, often exceeding $1,000,000,000 for blockbuster movies. Content protection for such products requires their encryption using strong block cipher cryptographic algorithms and cryptographic key lengths of at least 128 bits. However, for digital cinema content protection, it is the speed of decryption that is most important not the speed of the encryption.

Additionally, digital cinema products require copy protection so that illegal copies of cinema content can be detected and traced. Marking each individual copy of the digital cinema is part and parcel of an overall security regime. A mark identifying not only the copy but when it was displayed would be extremely desirable to allow the originator to detect where and when a copy was made of displayed imagery.

The present state of the art for strong 128 bit block cipher cryptographic algorithms is 10⁸ bits per second for encryption and about 50% slower for decryption.

The present state of the art for watermarks is that all are visually perceptible and all are breakable using standard and well-known cryptanalytic methods.

The present state of the art for the content protection of digital cinema products uses lossless compression, 128 bit block cipher decryption at rates of 5×10⁷ bits per second or less, and a store-and-forward concept. Store-and-forward means that after compression, encryption, and transmission of the digital cinema product to the projection site, then the digital cinema product is decrypted and decompressed and then stored in the clear on storage media before the projection process.

What is needed is means of encrypting and decrypting digital cinema products that can achieve data rates between 0.252×10¹⁰ bits per second to 0.504×10¹⁰ bits per second so that the digital cinema product can be decrypted in real time so as to obviate the need for store-and-forward. Further, a means of watermarking a digital cinema product is also needed that cannot be detected or removed without access to the original digital cinema product.

### SUMMARY OF THE INVENTION

The present invention is embodied as a system and method for protecting the content of digital cinema products using a non-algebraic cryptographic engine and a black metamer imprinting engine.

It is an object of the present invention to provide a high level of security for digital cinema products.

It is a further object of the present invention to provide for real time “on-the-fly” content protection of digital cinema products.

It is yet another object of the present invention to require no intermediate storage of the digital cinema product after decryption and decompression and its projection onto a display.

It is yet another object of the present invention to require no compression or decompression of the digital image while simultaneously providing for a high level of security.

It is yet another object of the present invention to provide a high level of security for digital imagery content by using a block cipher cryptographic algorithm with a 128 bit cryptographic key.

It is yet another object of the present invention to provide for decryption speeds in excess of 10¹⁰ bits per second, using a custom hardware implementation.

These and other objectives of the present invention will become apparent from a review of the general and detailed descriptions that follow. Referring to FIG. 1A, an embodiment of the present invention is illustrated. The originator of the digital cinema product uses digital cameras, computer generated images, and digital editing techniques to generate an original copy of the digital cinema product 100. The originator may elect to compress the digital cinema product 102. If compression is desired, the originator selects a compression algorithm or technique 105 and the digital cinema product is then compressed 110. The use of compression is not required to practice the present invention. In an embodiment of the present invention, the digital cinema product is not compressed. If compression is not desired, or following the completion of the compression process, the originator is then authenticated 115 by the cryptographic key management center 120. If authenticated, a cryptographic key management center generates a set of cryptographic keys for the originator to use and sends these keys to the originator using a secure key exchange protocol 125.

The originator then uses encryption mode of a non-algebraic cryptographic engine (sometimes referred to as a “NACE”) 130 and the set of cryptographic keys to generate sufficient encrypted copies of its original digital cinema product 135. A non-algebraic cryptographic engine meeting the requirements of the present invention is described in U.S. Patent Application entitled “Non-Alebraic Method of Encryption and Decryption” and filed on Aug. 30, 2002, which patent application is hereby incorporated by reference herein, in its entirety, for all purposes.

Referring to FIG. 1B, the encrypted copies of the digital cinema product are then distributed to one or more users 140, using cable, satellite, or DVD media.

Upon receipt of a copy of the digital cinema product, the user interfaces with the authentication center for two purposes: (1) authenticate the user 145; and (2) using a key exchange protocol, obtain the cryptographic key 150 for the decryption of the encrypted copy of the digital cinema product that the user now possesses.

Using the cryptographic key and the decryption mode of the non-algebraic cryptographic engine 155, the user then decrypts the encrypted copy of the digital cinema product 160.

Referring to FIG. 1C, if the received copy of the digital cinema product was compressed 162, the user then uses the previously selected compression algorithm 165 to decompress the digital cinema product 170. Otherwise, no decompression of the digital cinema product is required.

The system then uses a black metamer imprinting engine 170 (sometime referred to herein as a BMIE) to impose an identifier on the user's copy of the digital cinema product 175. A black metamer imprinting engine meeting the requirements of the present invention is described in U.S. Patent Application entitled “A System And Method For Imprinting A Digital Image With An Identifier Using Black Metamers” and filed on Aug. 31, 2002, which patent application is hereby incorporated by reference herein, in its entirety, for all purposes. This identifier will contain sufficient information to identify the user and the time and place of projection.

The digital cinema product is then used by the user (e.g., projected or displayed) 180. No intermediate storage of the clear text digital cinema product is required.

### BRIEF DESCRIPTION OF THE DRAWINGS

A better understanding of the present invention will be realized from the detailed description that follows, taken in conjunction with the accompanying drawings, in which:

FIGS. 1A, 1B and 1C are a block diagram illustrating an embodiment according to the present invention.

FIG. 2 is a block diagram illustrating the functionality and interfaces of a cryptographic key management system of an embodiment according to the present invention.

FIG. 3 is a flow diagram illustrating the generation of seed data of an embodiment according to the present invention.

FIG. 4 is a block diagram illustrating the notation of 128 bit words of an embodiment according to the present invention.

FIG. 5 is a flow diagram illustrating the generation of random numbers of an embodiment according to the present invention.

FIG. 6 is a flow diagram illustrating the generation of cryptographic keys of an embodiment according to the present invention.

FIG. 7 is a flow diagram illustrating an authentication protocol for originators of an embodiment according to the present invention.

FIG. 8 is a flow diagram illustrating a public key exchange of the DCPK cryptographic keys for the originator of an embodiment according to the present invention.

FIG. 9 is a flow diagram illustrating encryption of the original copy of a digital cinema product of an embodiment according to the present invention

FIG. 10 is a flow diagram illustrating an authentication protocol for users of an embodiment according to the present invention.

FIG. 11 is a flow diagram illustrating a public key exchange of the DCPK cryptographic keys for the user of an embodiment according to the present invention.

FIG. 12 is a flow diagram illustrating decryption of the encrypted original copy of an embodiment according to the present invention.

FIG. 13 is a flow diagram illustrating a use of black metamers of an embodiment according to the present invention.

### DETAILED DESCRIPTION OF THE INVENTION

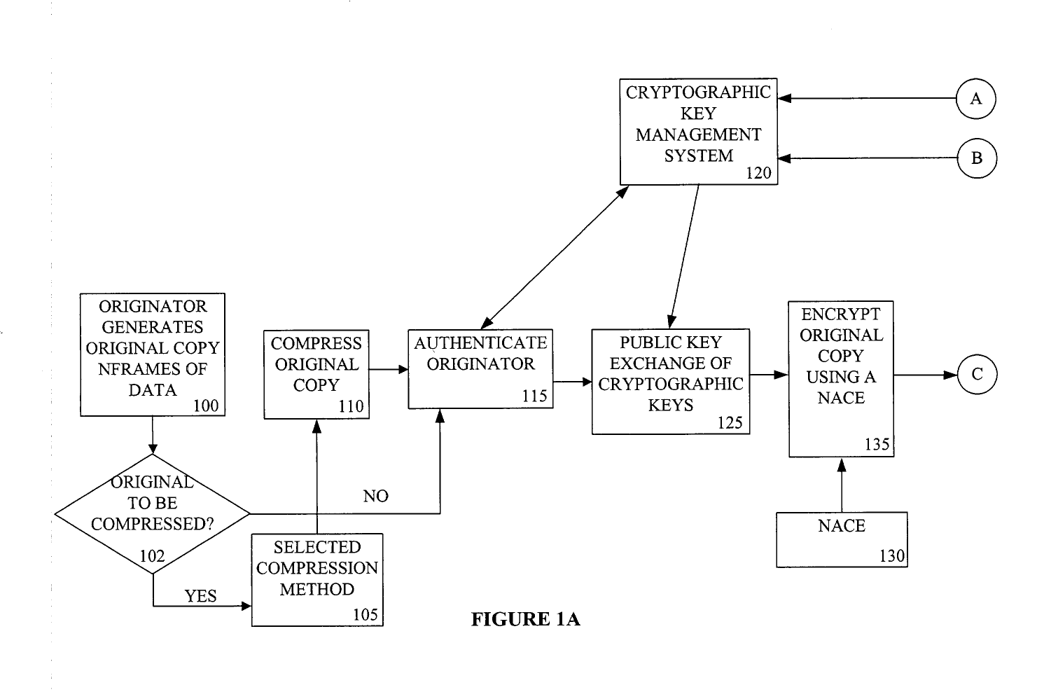

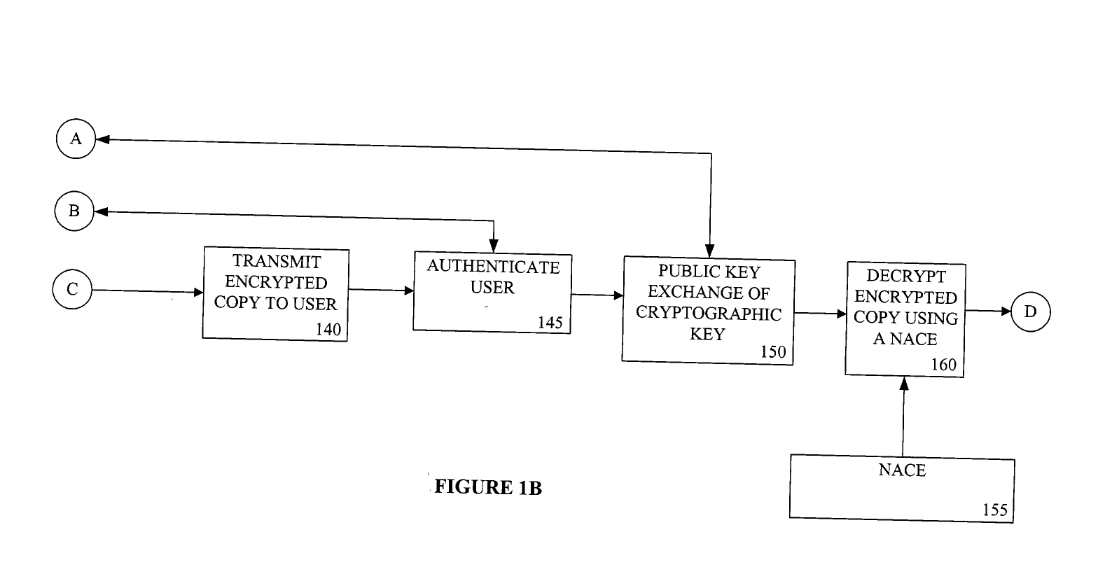

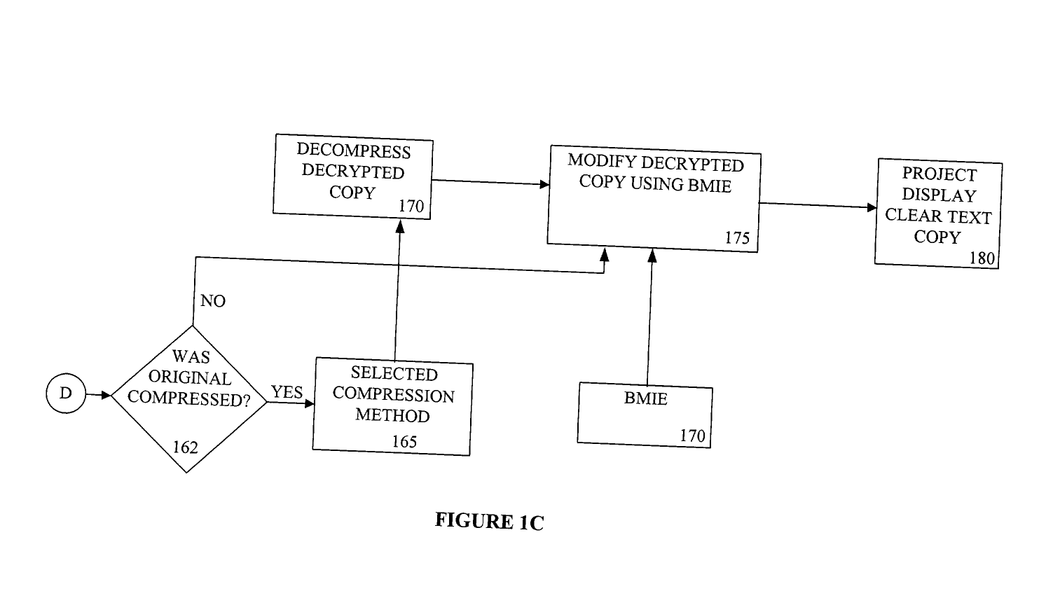

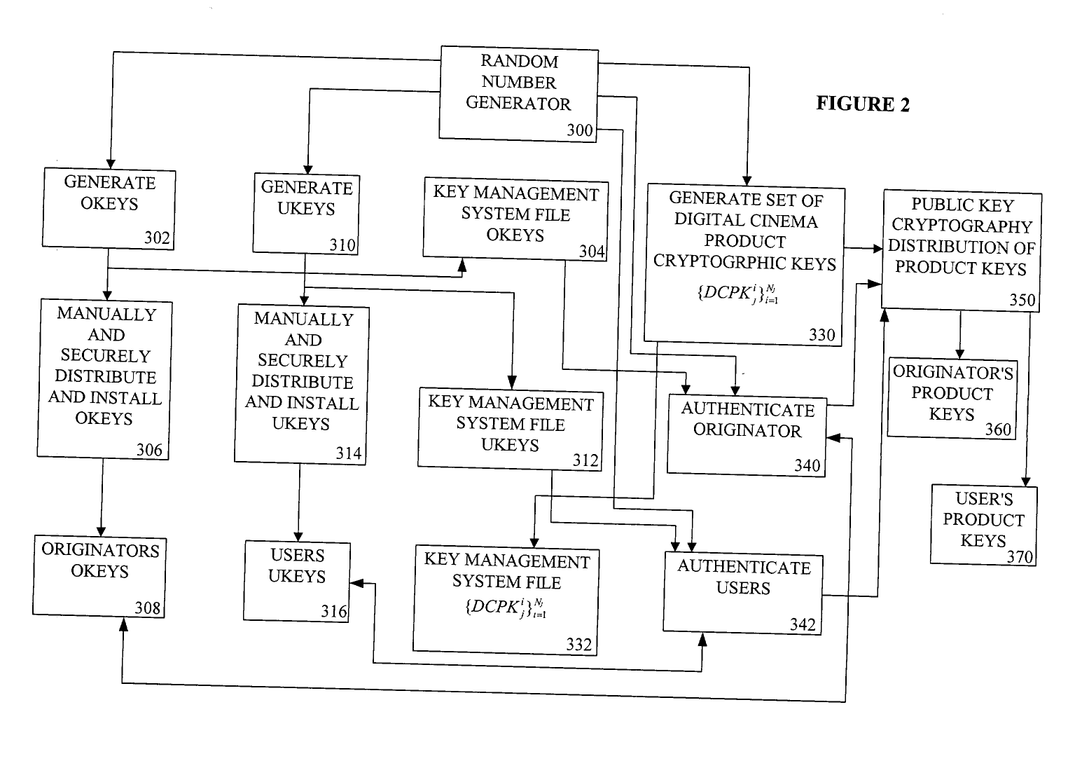

A flow diagram of an embodiment of the present invention has been described in reference to FIGS. 1A, 1B, and 1C. As illustrated therein, the present invention uses a cryptographic key management system to perform a number of tasks. These tasks as implemented in an embodiment of the present invention are illustrated FIG. 2 and comprise: generating random numbers to initiate key generation protocols 300; generating originator keys (OKEY) 302 to be used to authenticate originators; saving a copy of each OKEY to a key management system originator key file 304; manually and securely distributing OKEYs to each originator 306; storing the OKEY at an originator's facility 308; generating user keys (UKEY) 310 to be used to authenticate users; saving a copy of each UKEY to a key management system user key file 312; manually and securely distributing UKEYs to each user 314; storing the UKEY at the user's facility 316; generating a set of digital cinema product keys, (DCPK), for each digital cinema product 330; saving a copy of each DCPK to a key management system originator key file 332; authenticating each originator 340 and each user 342; using public key cryptography 350 to distribute the set of DCPKs to an originator for use in encryption of a digital cinema product 360 and a user specific DCPK to that user 370 for use in decryption of an originator's encrypted digital cinema product.

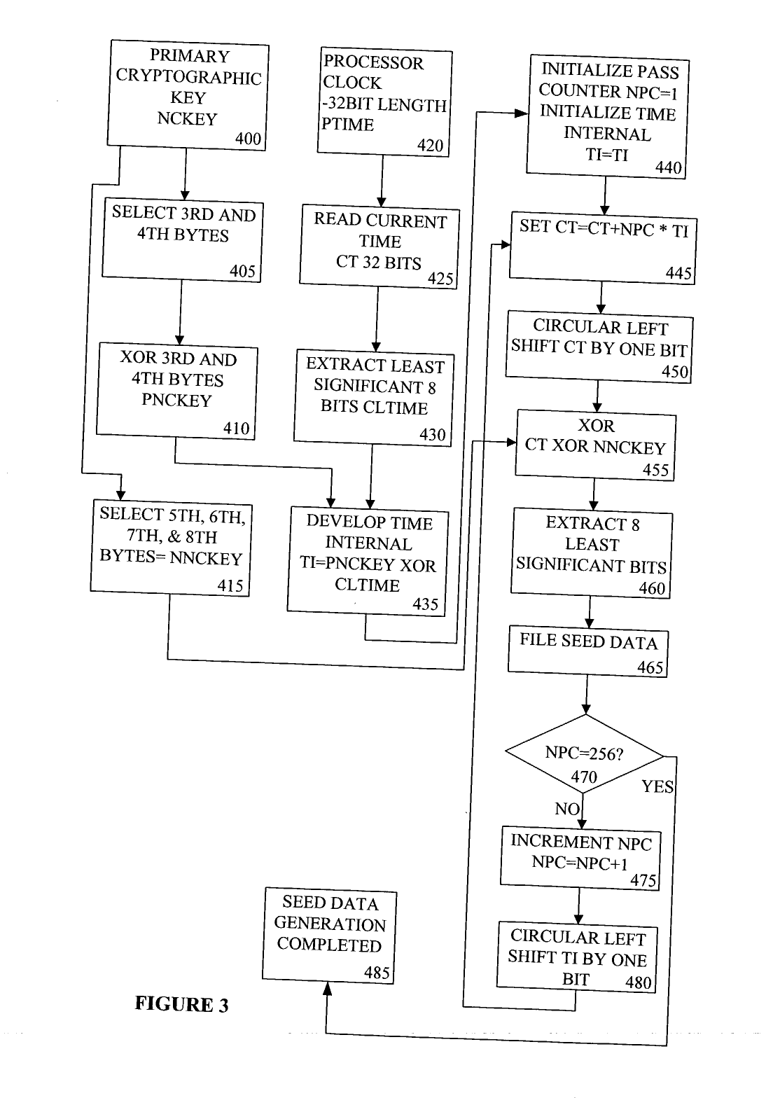

Seed data is required by the random number generator to generate sets of random numbers for use by the cryptographic key management system. FIG. 3 illustrates a flow diagram of the seed data generation process utilized in an embodiment of the present invention. Referring to FIG. 3, the first step comprises extracting two fragments from the cryptographic key management system's primary cryptographic key, NCKEY 400.

The first fragment is denoted by PNCKEY. It is obtained by selecting the third and fourth bytes (counting from the left) of NCKEY 405 and XORing (where XOR denotes the exclusive or logical bit arithmetic operation) these bytes 410 to form an 8-bit fragment PNCKEY.

The second fragment is denoted by NNCKEY, and is obtained by selecting the fifth, sixth, seventh, and eighth bytes of NCKEY and concatenating these bytes to form the 32 bit fragment NNCKEY 415.

Both of these fragments, PNCKEY and NNCKEY, are used in subsequent processing steps of the seed data generation.

The next step in the process of generating seed data is to read the current time and develop a time interval for the seed generation function. The system processor clock 420 is used as the source of time data. In an embodiment of the present invention, it is assumed that the system clock has a resolution of 32 bits, however this is not meant as a limitation. The current system clock is read and is denoted by CT 425.

Next the 8 least significant bits of CT are extracted to form an 8-bit segment, which is denoted by CLTIME 430.

Next the time interval, TI, is generated by XORing PNCKEY with CLTIME 435

The next step in the procedure for the generation of seed data is an iterative loop that generates 8-bit seed data at each step of the iterative process. An embodiment of the present invention performs 256 iterations and thus generates a total of 256 distinct 8-bit seed data words.

The iterative procedure is initialized by importing the time interval, TI, and setting the pass counter, NPC, to equal one 440.

Next CT is reset 445 according to the following equation:

CT=CT+NPC*TI (1)

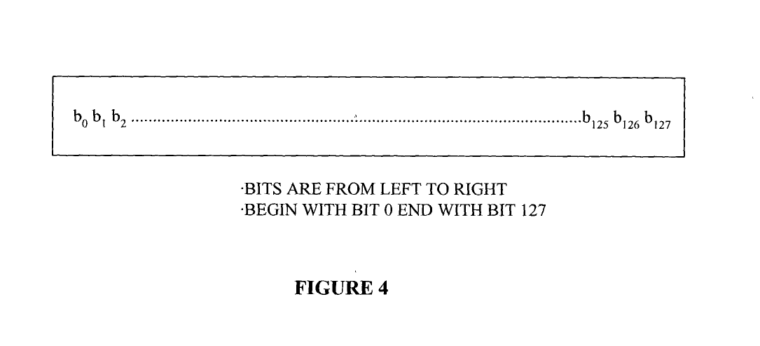

In the description of the iterative process that follows, a specific notation is used for 128 bit words. This notation is illustrated by FIG. 4, which reflects that the first bit of the word is the left most bit of the 128 bit word and is denoted by b₀, with bit numbers increasing to the right and the last bit denoted by b₁₂₇.

Referring again to FIG. 3, the next step in the iterative procedure is to perform a left circular shift of one bit on CT 450. A left circular shift of n bits is defined by the following equation:

$$C = CL ( n ) ∘ B \{ \begin{matrix} {c}_{i} = {b}_{i - n} & for 0 \leq i \leq M - n \\ {c}_{i} = {b}_{n - M + i - 1} & for M - n + 1 \leq i \leq M\end{matrix} \} \qquad ( 2 )$$

The next step in the iterative procedure of seed data generation is to XOR CT with NNCKEY 455 and then reset CT as is described by the following equation:

CT=CT XOR NNCKEY (3)

The next step in the iterative procedure is to extract the 8 least significant bits of CT 460. The result is denoted by SD and is an 8-bit seed data word. SD is then filed in the file of seed data 465.

The next step in the iterative process is to check the pass counter NPC 470. If NPC is less than 256, then the iterative process continues. First the pass counter, NPC, is incremented by one 475. Then TI is reset by performing a left circular shift of one bit 480 is as described by the following equation:

TI=CL(1)∘TI (4)

Then the iterative process resumes with the resetting of CT 445.

If the check of the pass counter, NPC, determines that NPC=256, then the generation of the required seed data has been completed 485.

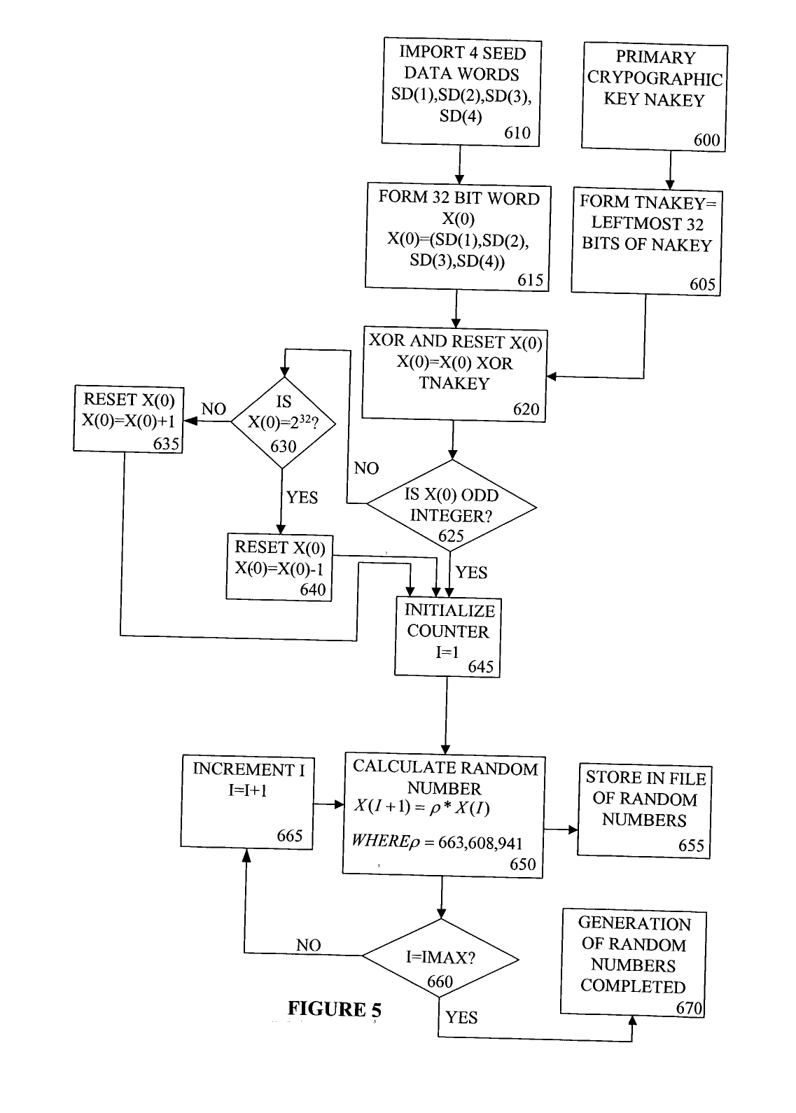

The random number generator uses the seed data words to generate a set of random numbers as illustrated by FIG. 5. Referring to FIG. 5, the first step in the procedure is to use the primary cryptographic key NAKEY 600 to form a 32-bit fragment by taking the left most 32 bits of NAKEY 605. This fragment is denoted by TNAKEY.

The next step in the procedure for the generation of random numbers is to import 4 seed data words 610. These are then used to form the 32-bit word X(0) 615.

The next step in the procedure is to XOR X(0) with TNAKEY and reset X(0) 620. This is illustrated by the following equation:

X(0)=X(0) XOR TNAKEY (5)

The next step is to determine if X(0) is an odd integer 625. If X(0) is odd, the process continues 645. If X(0) is an even integer, then a subsequent test is made to determine if X(0)=2³² 630. If the answer is yes then X(0) is reset 640 in accordance with the following equation:

X(0)=X(0)−1 (6)

If the answer is no, then X(0) is reset 635 in accordance with the following equation:

X(0)=X(0)+1 (7)

With X(0) established as an odd integer, the next step in the procedure is to initialize the counter. The counter, I, is initialized by setting it equal to one 645.

The next step in the procedure is to generate a random number 650, using the following equation:

X(I+1)=ρ*X(I) (8)

where ρ=663,608,941

The result is then stored in the file of random numbers 655.

The next step in the procedure is to determine if all of the random numbers have been generated. This is accomplished by checking to see if the counter I=IMAX 660. In the present embodiment, IMAX represents the number of random numbers needed for key generation and authentication. If the answer is no, then the counter I is incremented by one 665 and the iterative process is resumed 650. If the answer is yes, then the process of generating random numbers is completed 670. The random numbers are available for use in the generation of cryptographic keys and in the authentication process.

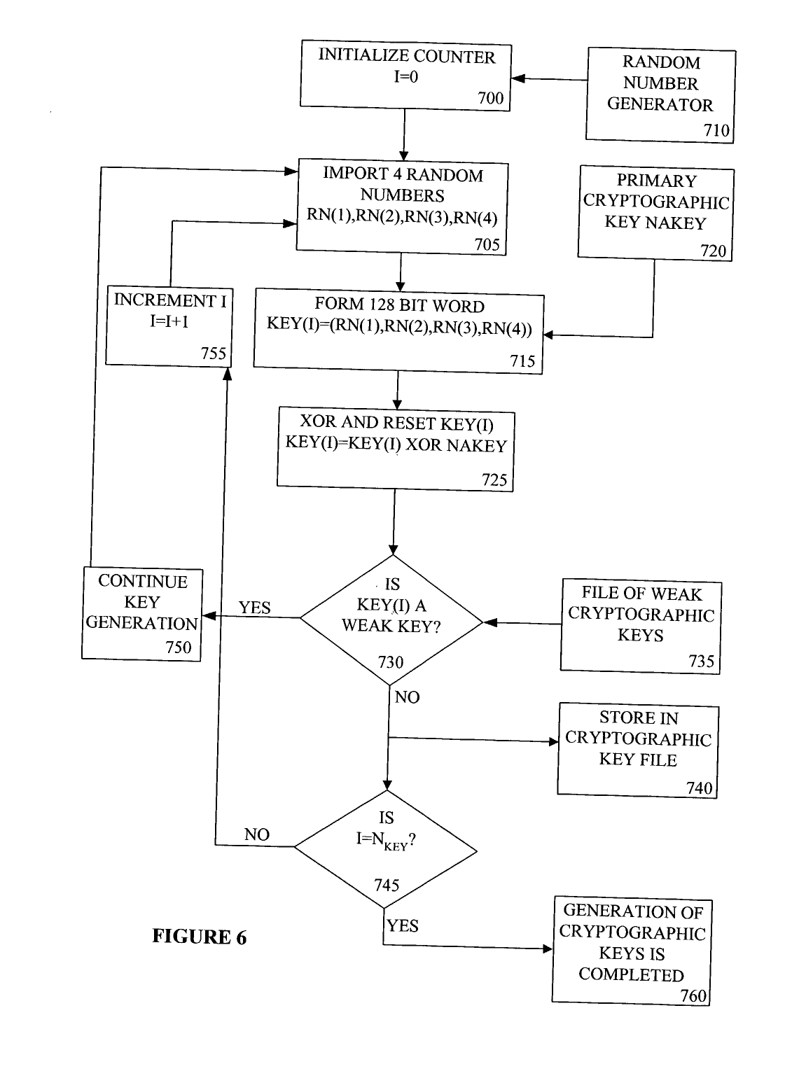

The next functionality is the generation of cryptographic keys. The same cryptographic key generation process is used for OKEYs, UKEYs, and DCPKs. The common key generation process is illustrated by FIG. 6, where the process generates a generic cryptographic key KEY, which represents either OKEY, UKEY, or DCPK.

The first step in the cryptographic key generation process is to initialize the counter I. This is accomplished by setting I=1 700.

The next step in the process is to import four random numbers 705 from the random number generator 710. These random words, each 32 bits, are denoted as RN(1), RN(2), RN(3), and RN(4). These four random words are then used to form a 128 bit word, denoted by KEY(I), and generated by concatenating the random words 715 as described by the following equation:

KEY(I)={RN(1), RN(2), RN(3), RN(4)} (9)

The next step in the process is to obtain the primary cryptographic key NAKEY 720, XOR Key (I) with NAKEY, and reset KEY(I) 725. This is illustrated by the following equation:

KEY(I)=KEY(I) XOR NAKEY (10)

Every cryptographic algorithm has a small set of “weak” cryptographic keys, such as keys consisting of all 0's and keys consisting of all 1's. These are ascertained during the development of a specific embodiment of the cryptographic algorithm and are made available to all users of the cryptographic key who need to generate cryptographic keys. In an embodiment of the present invention, KEY(I) is checked 730 against a file of weak keys 735. If it is determined that KEY(I) is a “weak” cryptographic key, then this KEY(I) is discarded and the key generation process resumed 750 by importing four more random numbers as is illustrated in FIG. 6 705. If it is determined that KEY(I) is not a “weak” cryptographic key, then KEY(I) is stored in the file of cryptographic keys 740.

Next a check is made to determine if a sufficient number of cryptographic keys have been generated. This is accomplished by checking if I=N_{KEY} 745, where N_{KEY} is the number of required cryptographic keys. If the answer is no, then I is incremented by one 755 and the process of generating cryptographic keys continues 705. If the answer is yes then the iterative process of cryptographic key generation terminates 760 as all required cryptographic keys have been generated.

Referring back to FIG. 2, an additional task of the cryptographic key management system is to manually and securely distribute and install OKEYs at the originators sites and UKEYs at the user sites. As is illustrated in FIG. 1A, the originator generates a digital cinema product consisting of NFRAMES of frames of data. The originator then requests a set of {DCPKᵢ}ᵢ₌₁^{N}^{_{cc}} cryptographic keys from the cryptographic key management system, where the total number of DCPK cryptographic keys, N_{c}, is sufficient for the originator's use plus any additional file and storage copies that the originator may require.

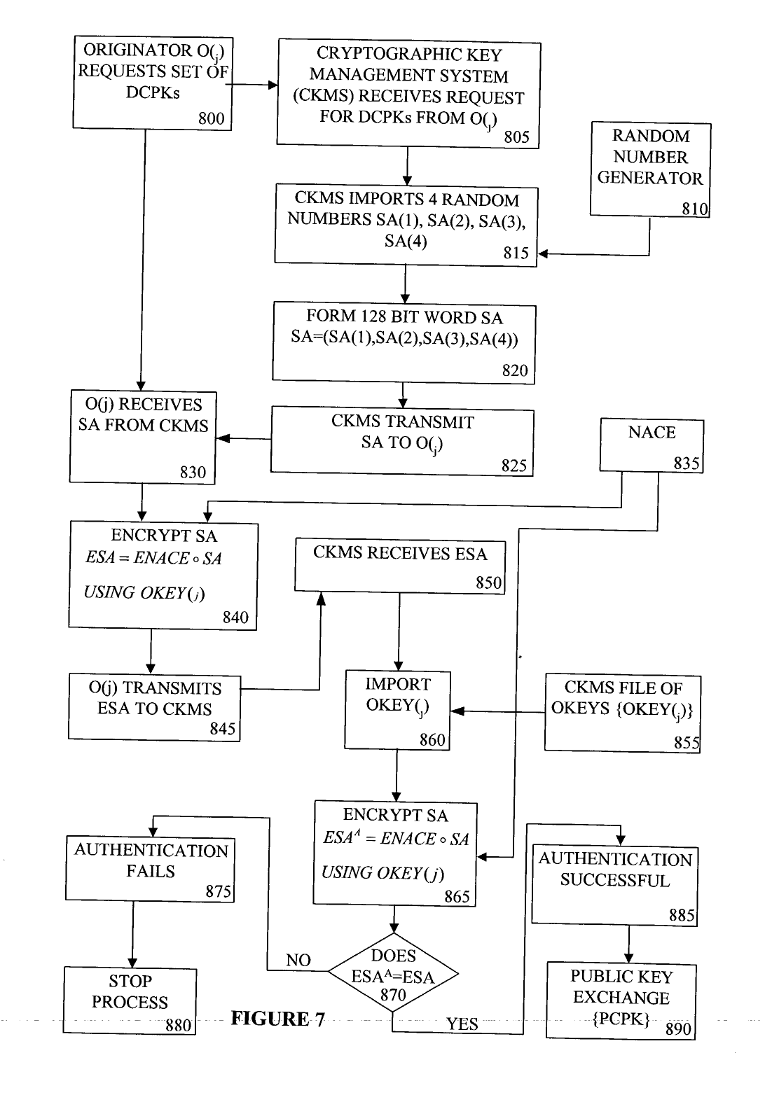

The cryptographic key management system uses an authentication procedure to establish the identity of the originator. This is to prevent man-in-the-middle attacks against the public key exchange of cryptographic keys. FIG. 7 illustrates an authentication protocol for the originator as used in an embodiment of the present invention.

One of the originators, O(j), requests a set of N_{c} DCPK cryptographic keys 800 from the cryptographic key management system, denoted subsequently by CKMS. Referring to FIG. 7, the CKMS receives the request 805 and begins the authentication protocol by importing four 32-bit random numbers 815 from the file of random number 810 (previously discussed in reference to FIG. 6). These random numbers are denoted by SA(1), SA(2), SA(3), and SA(4). The next step in the procedure is to form a 128-bit word, which is denoted by SA 820. This is achieved by concatenating the four random numbers as described by the following equation:

SA={SA(1),SA(2),SA(3),SA(4)} (11)

The next step in the procedure is for the CKMS to transmit the 128-bit word SA to O(j) 825. The transmission can be any communications system available as it is not necessary for SA to be secure. It does not impact the overall security of the system if an adversary intercepts SA.

The originator, O(j), receives SA 830 and then encrypts SA 840 using the encryption mode of the NACE (the encryption mode of the NACE is denoted by ENACE) and his own OKEY(j) 835. The encrypted version of SA is denoted by ESA. This is described by the following equation:

ESA=ENACE(OKEY(j))∘SA (12)

The originator, O(j), then transmits ESA to the CKMS 845. After the CKMS receives the ESA 850, it imports OKEY(j) 860 from the CKMS file of OKEYs 855.

The CKMS then encrypts SA using ENACE and its file copy of OKEY(j) 865. The CKMS encrypted version of SA is denoted by ESAˆ . This encryption process is illustrated by the following equation:

ESAˆ =ENACE(OKEY(j))∘SA (13)

Next a check is made to see if ESA=ESAˆ 870. If the answer is yes, then authentication is successful 885 and the public key exchange of the set of DCPKs may proceed 890. However if the answer is no, then authentication fails 875, and the process is terminated with appropriate security responses 880.

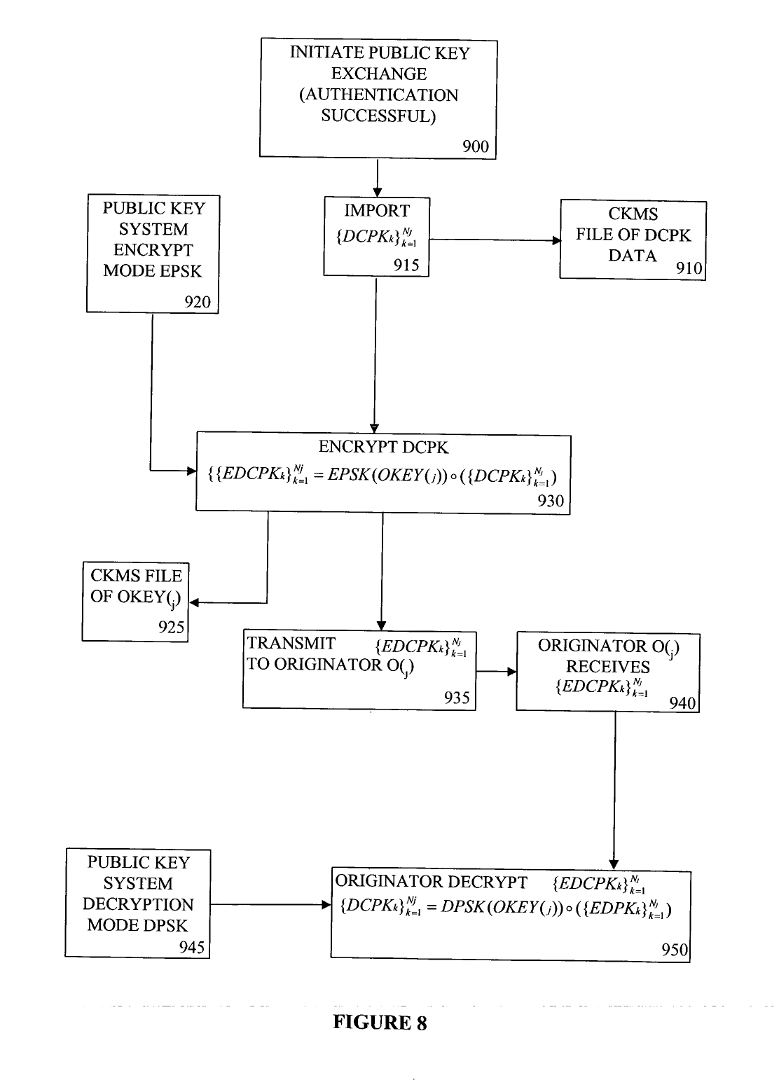

The public key exchange process by which the originator receives its set of DCPKs (digital cinema product keys) involves both the CMSK and the originator O(j). Referring to FIG. 8, the process is initiated only if the CMSK has determined that authentication was successful for O(j) 900.

The CMSK imports the appropriate set of DCPK data 915, which is denoted by {DCPKₖ}ₖ₌₁^{N}^{ⱼ}, from the CMSK file of DCPK data 910.

A public key exchange system (denoted by PSK) is selected 920 to perform the secure of the public key exchange functions of the CMSK. The encryption mode of the selected PSK is denoted by EPSK and the decryption mode denoted by DPSK. There are a number of well-known and secure public key cryptographic systems that may be used employed to serve this function. By way of example, and not as a limitation, RSA, Diffie-Hellman, ECDH, MQV, and Raike Public-Key Cryptosystem are public key exchange systems that may be used in the present invention. Other systems may also be utilized without departing from the scope of the present invention as disclosed herein.

Referring to FIG. 8, the DCPK data, {DCPKₖ}ₖ₌₁^{N}^{ⱼ}, is encrypted 930 using the encryption mode, EPSK, of the public key system and the orginator's cryptographic key OKEY(j). This is illustrated by the following equation:

{EDCPKₖ}ₖ₌₁^{N}^{ⱼ}=EPSK(OKEY(j))∘{DCPKₖ}ₖ₌₁ⁿ^{ⱼ} (14)

The CMSK sends {EDCPKₖ}ₖ₌₁^{N}^{ⱼ} to the originator O(j) 935 who receives the data, {EDCPKₖ}ₖ₌₁^{N}^{ⱼ}, 940 from the CMSK. O(j) then decrypts this data 950 using the decryption mode of the public key cryptographic system 945 and the cryptographic key OKEY(j) as is illustrated by the following equation:

{DCPKₖ}ₖ₌₁^{N}^{ⱼ}=DPSK(OKEY(j))∘{EDCPKₖ}ₖ₌₁ⁿ^{ⱼ} (15)

This completes the public key exchange of the DCPK cryptographic keys.

In the next segment of the present invention, the digital cinema product is encrypted. As previously noted, compression of the digital cinema product is not required to practice the present invention. However if the originator requires a compression technique, then any compression technique may be used without exceeding the scope of the present invention. The description that follows is of an embodiment of the present invention wherein no compression is required by the originator. If a compression technique were deemed necessary, then as is illustrated by FIG. 1, the compression segment precedes the encryption segment of the process.

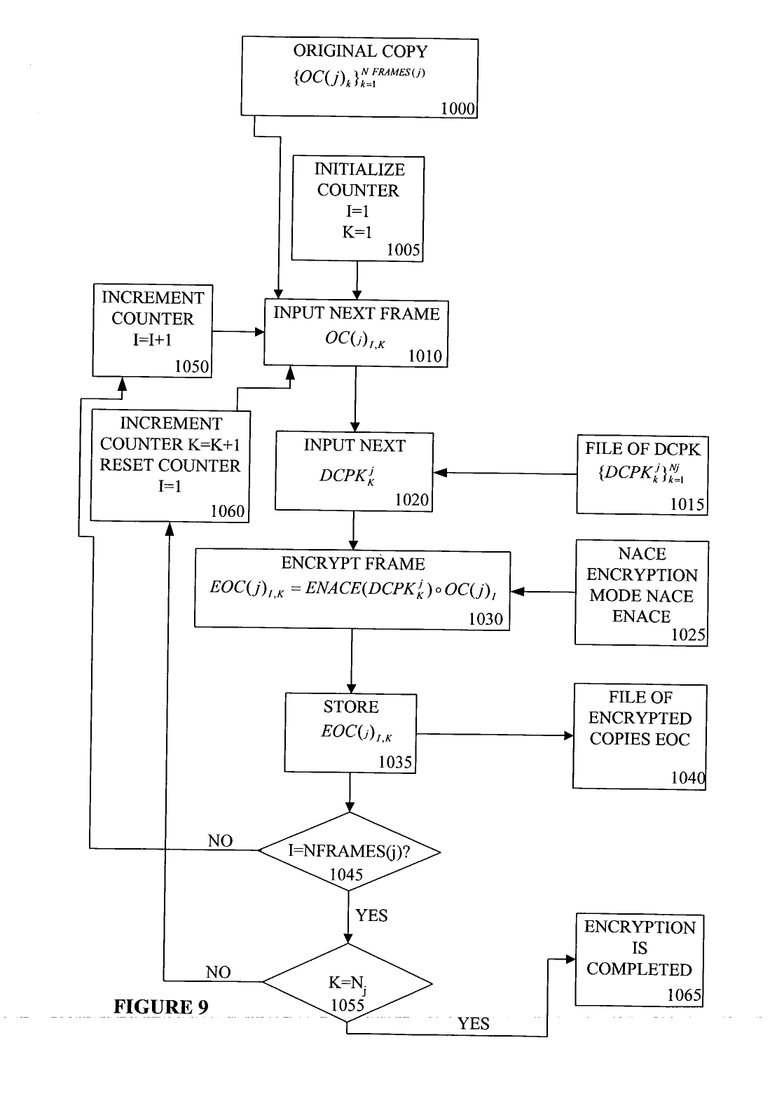

Referring to FIG. 9, the process of encrypting the originator's original copy of the digital cinema product is illustrated. The originator's original copy is denoted by OC(j), for the originator O(j). This digital cinema product comprises NFRAMES(j) 1000.

The counters I and K are initialized by setting I=1, and also setting K=1 1005.

The next successive frame, OC(j)_{I} of original copy from the originator, O(j), is inputted 1010 and the next DCPK_{K}^{J} (digital cinema product key) is imported 1020 from the originator's file of DCPK cryptographic keys 1015.

The frame of data, OC(j)_{I}, is then encrypted 1030 using the NACE's encryption mode, ENACE, and the appropriate cryptographic key, DCPK_{K}^{J} 1025. This is illustrated by the following equation, where EOC(j)_{I} represents the encrypted version of the original copy:

EOC(j)_{I}=ENACE(DCPK_{K}^{J})∘OC(j)_{I} (16)

The encrypted version of the original copy, EOC(j)_{I}, is then filed 1035 in of encrypted EOC data 1040.

A check is then made to determine if all the frames of the original copy have been encrypted. This is accomplished by checking to see if I=NFARAMES(j) 1045. If the answer is “no”, then the counter, I, is incremented by one 1050 and the encryption on process continues 1010.

If the answer is “yes”, then all of the frames in the original copy have been encrypted. In this case a check is made to determine if any additional encrypted copies are required by the originator, O(j). This is accomplished by checking if K=Nⱼ 1055. If the answer is no, then additional encrypted copies of the original copy are required by the originator. In this case K is incremented by one and I is reset to equal one 1060 and the encryption processing continues 1010. If the answer is yes, the encryption of all required copies of the original copy is complete 1065.

Referring again to FIG. 1B, another task of the CKMS (cryptographic key management system) is to deliver an encrypted copy of the digital cinema product to the user. Where the digital cinema product is in the form of a data file, the present invention may be practice using any communications system or network. Where the digital cinema product is incorporated into tangible media, the present invention may be practiced using any means of delivery of tangible media. By way of example, a digital cinema product may be transmitted to a user over a satellite or cable network, or delivered to the user in the form of DVDs.

When the user receives an encrypted copy of the original copy of the digital cinema product, the user is ready to project or display the original copy of the digital cinema product. This requires that the user decrypt the encrypted version of the original copy to obtain a copy of the original copy for displaying or projection. As noted previously, the present invention permits the decryption of an encrypted digital cinema product at speeds sufficient to allow the digital cinema product to be used without the need for intermediate storage of the clear text digital cinema product.

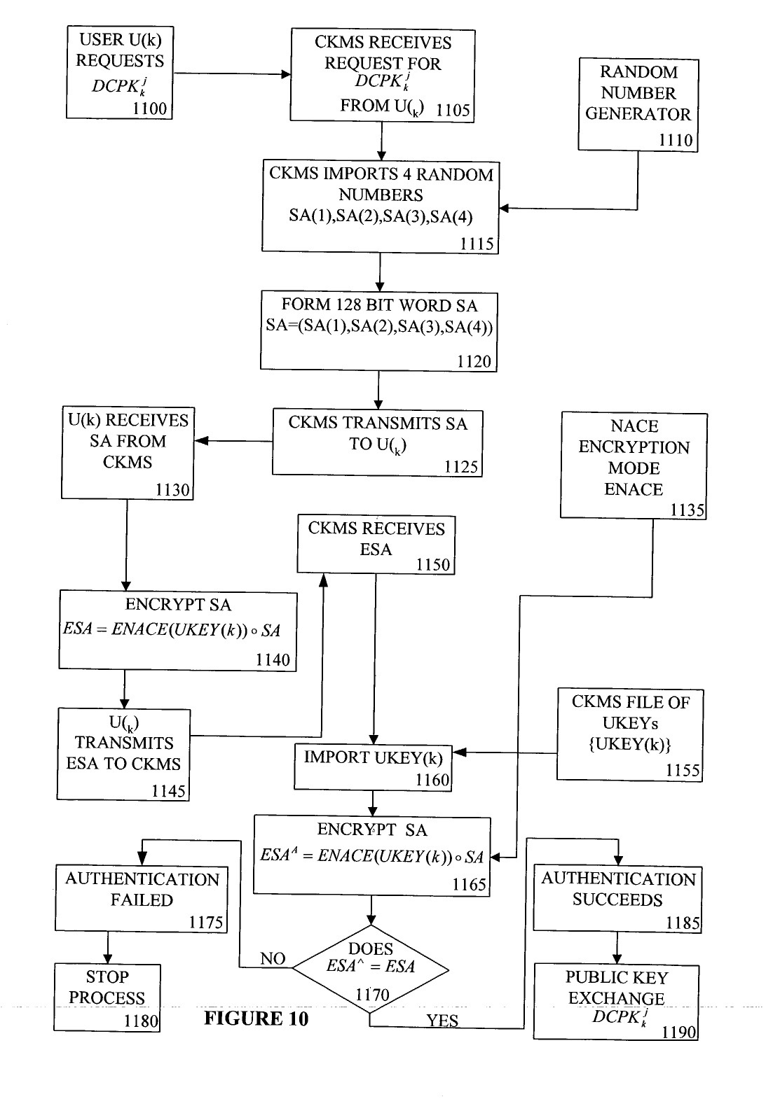

The cryptographic key management system uses an authentication procedure to establish the identity of the user. This is to prevent man-in-the-middle attacks against the public key exchange of cryptographic keys. FIG. 10 illustrates an authentication protocol for the user as used in an embodiment of the present invention.

One of the users, U(k), requests a DCPK cryptographic key from the cryptographic key management system 1100, denoted by CKMS. As illustrated in FIG. 10, the CKMS receives the request 1105 and begins the authentication protocol by importing four 32 bit random numbers 1115 from the file of random number 1110 (previously discussed in reference to FIG. 6). These random numbers are denoted by SA(1), SA(2), SA(3), and SA(4). The next step in the procedure is to form a 128-bit word, which is denoted by SA 1120. This is achieved by concatenating the four random numbers as described by the following equation:

SA={SA(1),SA(2),SA(3),SA(4)} (17)

The next step in the procedure is for the CKMS to transmit the 128 bit word SA to U(k) 1125. The transmission can be any communications system available as it is not necessary for SA to be secure. It does not impact the overall security of the system if an adversary intercepts SA.

The originator, U(k), receives SA 1130, and then encrypts SA 1140 using the encryption mode of the NACE 1135 and his own UKEY(k). The encrypted version of SA is denoted by ESA. This is described by the following equation:

ESA=ENACE(UKEY(k))∘SA (18)

The user, U(k), then transmits ESA to the CKMS 1145. After the CKMS receives the ESA 1150, it imports UKEY(k) 1160 from the CKMS file of UKEYs 1155.

The CKMS then encrypts SA using the encryption mode of the NACE and its file copy of UKEY(k) 1165. The CKMS encrypted version of SA is denoted by ESAˆ . This encryption process is illustrated by the following equation:

ESAˆ =ENACE(UKEY(k))∘SA (19)

Next a check is made to see if ESA=ESAˆ 1170. If the answer is yes, then authentication is successful 1185 and the public key exchange of the DCPKs may proceed 1190. However if the answer is no, then authentication fails 1175, and the process is terminated with appropriate security responses 1180.

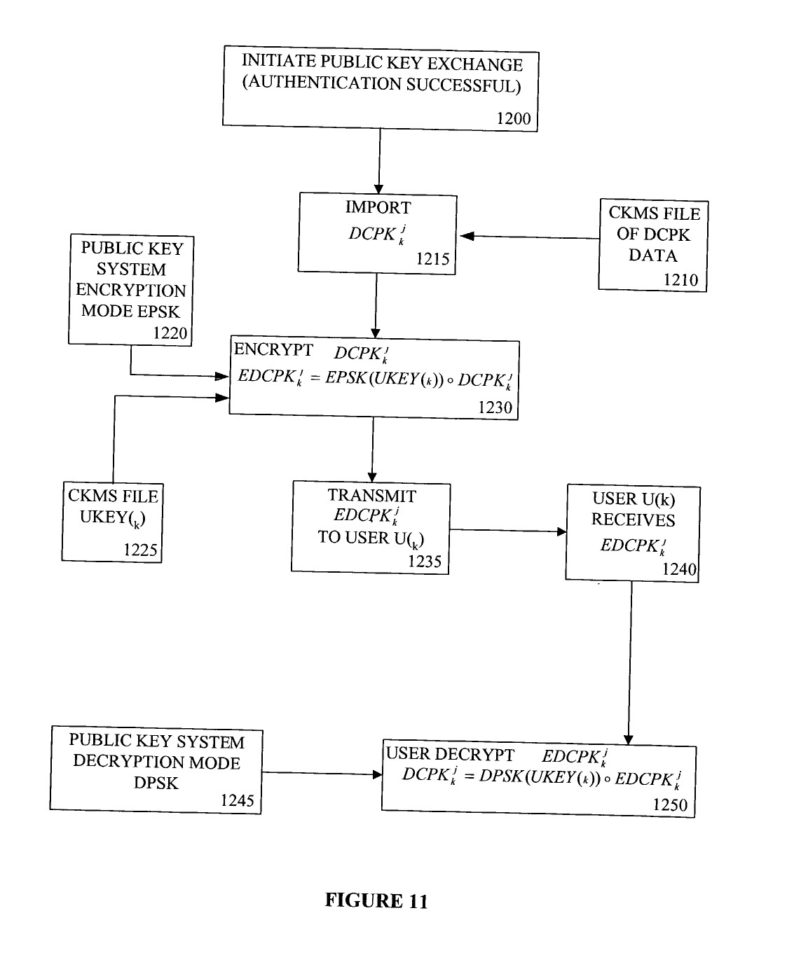

The public key exchange process by which the user receives its DCPK (digital cinema product key) involves both the CMSK and the user U(k). Referring to FIG. 11, the process is initiated 1200 only if the CMSK has determined that authentication was successful for U(k).

The CMSK imports the appropriate DCPK data 1215, which is denoted by DCPKₖ^{J} from the CMSK file of DCPK data 1210.

A public key exchange system (denoted by PSK) is selected 1220 to perform the secure of the public key exchange functions of the CMSK. The encryption mode of the selected PSK is denoted by EPSK and the decryption mode denoted by DPSK. There are a number of well-known and secure public key cryptographic systems that may be used employed to serve this function. By way of example, and not as a limitation, RSA, Diffie-Hellman, ECDH, MQV, and Raike Public-Key Cryptosystem are public key exchange systems that may be used in the present invention. Other systems may also be utilized without exceeding the scope of the present invention.

Referring to FIG. 11, the DCPK data, DCPKₖ^{J} is encrypted 1230 using the encryption mode, EPSK, of the public key system and the cryptographic key of the user UKEY(k) 1225. This is illustrated by the following equation:

EDCPKₖ^{J}=EPSK(UKEY(k))∘DCPKₖ^{J} (20)

The CMSK sends EDCPKₖ^{J} to the user U(k) 1235 who receives the data, EDCPKₖ^{J}, 1240 from the CMSK. U(k) then decrypts this data 1250 using the decryption mode of the public key cryptographic system and the user's cryptographic key UKEY(k) 1245 as is illustrated by the following equation:

DCPKₖ^{J}=DPSK(UKEY(k))∘EDCPKₖ^{J} (20)

This completes the public key exchange of the DCPK cryptographic key.

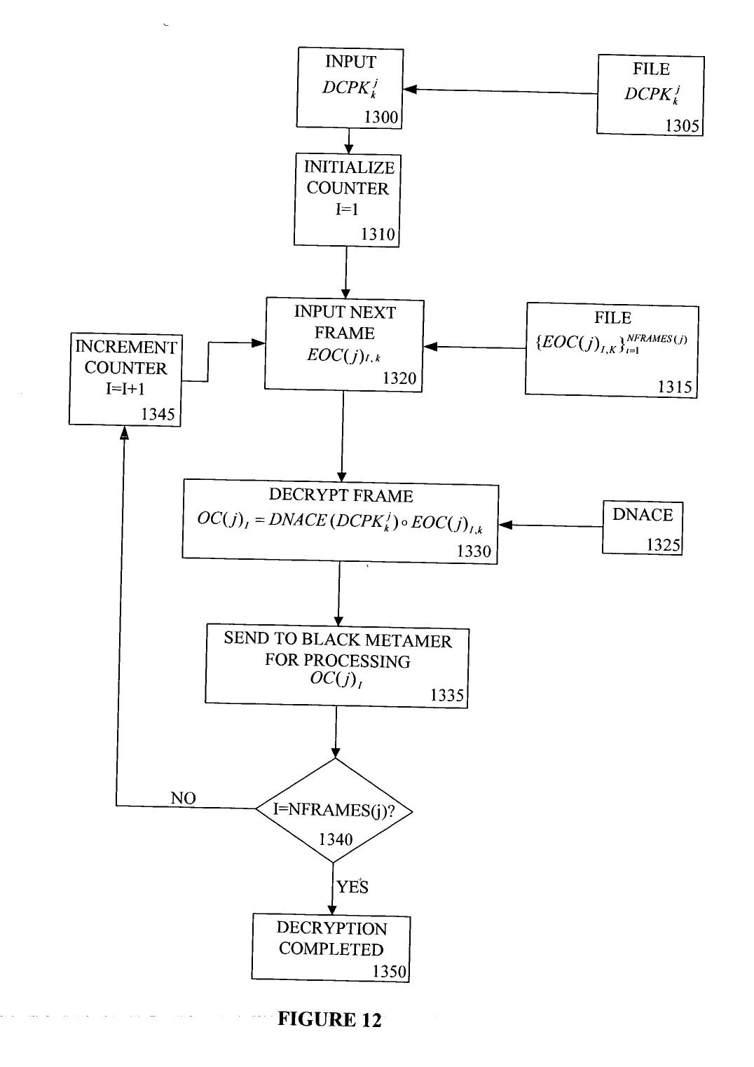

In the next segment of the present invention, the digital cinema product received by the user is decrypted. As previously noted, compression of the digital cinema product is not required to practice the present invention. If, however, the originator compressed the digital cinema product, the user prior to decryption must decode it. The decryption process illustrated in FIG. 12 utilizes a digital cinema product that was not previously compressed. Had the digital cinema product been compressed, then the decompression step would precede the decompression process therein described.

The decryption of the encrypted copy of the digital cinema product is illustrated in FIG. 12. DCPKₖ^{J} is retrieved 1300 from the user's file 1305. The counter, I, is initialized, which is accomplished by setting I=1 1310. The next successive frame of encrypted data, EOC(j)_{I,k} is inputted 1320 from the user's file 1315 of all the encrypted copies of the digital cinema product.

The current frame of data, EOC(j)_{I,k}, is then decrypted 1330 using the decryption mode of the NACE 1325. The decryption mode is denoted by DNACE. The following equation illustrates the decryption process.

OC(j)_{I}=DNACE(DCPKₖ^{j})∘EOC(J)_{I,k} (22)

This produces a clear text copy of the original copy ready for projection or display. However, before projection or display a black metamer identifier is added 1335 to further safeguard an adversary from copying the digital cinema product during its display. This will be discussed in a subsequent paragraph. In another embodiment of the present invention, the black metamer identifier is omitted.

A check is then made to determine if all the encrypted frames have been decrypted. This is accomplished by checking to see if I=NFRAMES(j) 1340. If the answer is no, then the counter I is incremented by one 1345 and the decryption process continued 1320. If the answer is yes, then all of the encrypted files have been decrypted and the processing of this segment is completed 1350

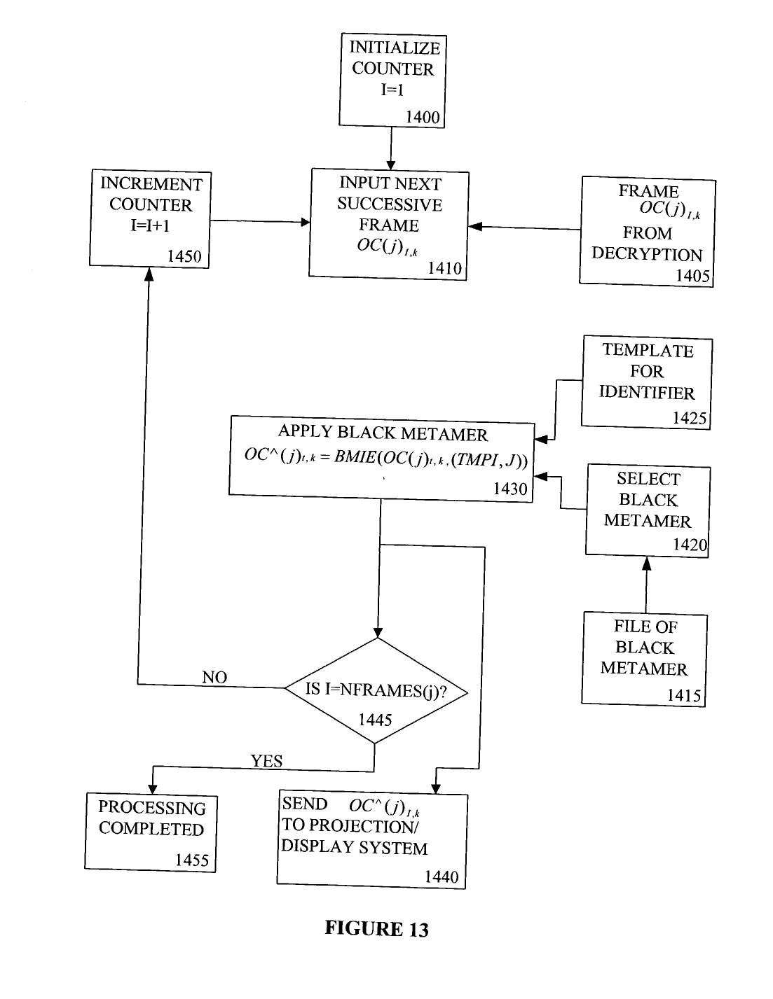

The black metamer processing segment is illustrated in FIG. 13. This processing segment is used as an additional copy protection technique. If the decrypted copy of the encrypted original copy was projected on a screen at a movie theater, then an adversary could make a copy of the digital cinema product through the simple mechanism of imaging the presentation with a high-resolution digital camera. It is desirable, therefore, to be able to ascertain when and where copies are made of the projected or displayed contents of a digital cinema product. The use of a black metamer imprinting engine provides this capability.

When black metameric stimuli are added to the visual stimuli that drives a projector or display unit, then the human vision perception is the same. Human vision perception cannot tell if there are black metamers in the imagery data or not. This provides for an incredible and powerful way to add identifiers such as watermarks, fingerprints, or identification data to each frame of data that is projected or displayed. Techniques exist for identifying the black metamers in each frame, thus one can examine a copy that has been pirated, extract the black metamers and uncover the identifier for each frame that was copied in an unauthorized manner.

Referring to FIG. 13, the counter I is set to one 1400 and the next successive frame of clear text imagery data is obtained 1410 from the decryption process previously described 1405. In this embodiment of the present invention, this is the last frame that was decrypted. This frame is denoted by OC(j)_{I,k}.

Black metamers are prevalent and readily computed. In the embodiment of the present invention illustrated in FIG. 14, a file of black metamers is established in advance 1415 from which a black metamer is selected 1420. However, this is not meant as a limitation. In another embodiment, a black metamer can be computed in real time. In the embodiment illustrated in FIG. 14, a template of pixel modifications by black metamers has previously been derived 1425. A template may comprise any desirable identifying data. By way of example and not as a limitation, the template may provide the date, time, and geolocation of the projection or displaying of the image. In the alternative, the template could comprise a watermark. The content of the template is an option of the originator.

From a structural perspective, the template is a pixel map, thus giving the coordinates of all the pixels that require modification by black metamers. If a single frame of imagery data consists of Nrows and Ncolumns of pixels, then a template pixel map, TMP is defined by the following equation:

$$TMP ( I , J ) = \{ \begin{matrix}0 & no black metamer \\ 1 & add black metamer\end{matrix} \} \\ where I = 1 , … , Nrows \\ and J = 1 , … , Ncolumns \qquad ( 23 )$$

The black metamer imprinting engine, BMIE, takes no action when the value of TMP(I,J) is zero, and adds the selected black metamer to each pixel whose TMP(I,J) value is one in accordance with the following equation:

OCˆ (j)_{t,k}=BMIE(OC(j)_{t,k}∘(TMPI,J)

After the processing of each individual frame of imagery data, that frame is immediately available for use by the user. For example, in an embodiment of the present invention, the individual frame is sent to a projector or display unit for processing by that unit.

A check is made to determine if the last frame has been processed. This is accomplished by checking if I=NFRAMES(j) 1445. If the answer is no, then the counter I is incremented by one 1450 and processing continues 1410. If the answer is yes, then all processing is completed 1455.

A system and method for copy protecting digital cinema products has now been illustrated. As described herein, the system and method for copy protecting digital cinema products permits the content of protected digital cinema product to be viewed and/or displayed in real time without the need for intermediate storage of the clear text data. It will be understood by those skilled in the art of the present invention that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. In a network wherein an originator has an originator device and the user has a user device and wherein the originator device and the user device communicate with a cryptographic key management system and with each other, a method for protecting a digital cinema product of an originator, wherein the method comprises:
authenticating an originator to the cryptographic key management system;
receiving at the originator device a digital cinema product key from the cryptographic key management system only if the originator is authenticated;
using a non-algebraic cryptographic engine and the digital cinema product key received at the originator device to encrypt a digital cinema product of the originator;
sending the encrypted digital cinema product to a user;
authenticating the user to the cryptographic key management system;
receiving at the user device the digital cinema product key from the cryptographic key management system only if the user is authenticated; and
using a non-algebraic cryptographic engine and the digital cinema product key received at the user device to decrypt the digital cinema product received at the user device.

2. The method according to claim 1 wherein the cryptographic key management system is selected from the group consisting of RSA, Diffie-Hellman, ECDH, MQV, and Raike Public-Key Cryptosystem.

3. The method according to claim 1 further comprising imprinting the digital cinema product received at the user device after decryption of the encrypted digital cinema product with an identifier using a black metamer imprinting engine.

4. The method according to claim 3 wherein the identifier is selected from the group consisting of watermarks, fingerprints, and text.

5. A system for protecting a digital cinema product of an originator, the system comprising an originator device and a user device in communication with a key management system and with each other wherein:
the originator device comprises a first processor, and a first memory system, the first memory system bearing first software instructions adapted to enable the first processor to implement the steps of:
authenticating an originator to the cryptographic key management system;
receiving at the originator device a digital cinema product key from the cryptographic key management system only if the originator is authenticated;
using a non-algebraic cryptographic engine and the digital cinema product key received at the originator device to encrypt a digital cinema product of the originator;
sending the encrypted digital cinema product to a user; and
the user device comprises a second processor, and a second memory system, the second memory system bearing second software instructions adapted to enable the second processor to implement the steps of:
authenticating the user to the cryptographic key management system;
receiving at the user device the digital cinema product key from the cryptographic key management system only if the user is authenticated; and
using a non-algebraic cryptographic engine and the digital cinema product key received at the user device to decrypt the digital cinema product received at the user device.

6. The system according to claim 5 wherein the cryptographic key management system is chosen from the group consisting of RSA, Diffie-Hellman, ECDH, MQV, and Raike Public-Key Cryptosystem.

7. The system according to claim 5 wherein the second software instructions are adapted to enable the second processor to implement the further steps of:
selecting an identifier; and
imprinting the digital cinema product received at the user device after decryption of the encrypted digital cinema product with an identifier using a black metamer imprinting engine.

8. The system according to claim 7 wherein the identifier is selected from the group consisting of watermarks, fingerprints, and text.
